(19) United States
(12) Patent Application Publication
(10) Pub. No.: US 2020/0244950 A1
(43) Pub. Date: Jul. 30, 2020

(54) Image Sensor Blemish Detection

(71) Applicant: GoPro, Inc., San Mateo, CA (US)

(72) Inventors: Fan Wang, San Mateo, CA (US); Feng Li, San Jose, CA (US)

(21) Appl. No.: 16/625,190

(22) PCT Filed: Jun. 21, 2018
(86) PCT No.: PCT/US2018/038746

§ 371 Date: Jan. 29, 2020

Related U.S. Application Data
(60) Provisional application No. 62/525,987, filed on Jun. 28, 2017.

(51) Int. Cl. H04N 17/00; H04N 5/367; G06T 5/00; G06T 7/00; H04N 9/73

(52) U.S. Cl. CPC H04N 17/002; H04N 5/367; G06T 5/002; G06T 2207/10004; H04N 9/73; G06T 2207/30168; G06T 7/0002

(57) ABSTRACT

Systems and methods are disclosed for testing image capture devices. For example, methods may include obtaining a test image from an image sensor; applying a low-pass filter to the test image to obtain a blurred image; determining an enhanced image based on a difference between the blurred image and the test image; comparing image portions of the enhanced image to a threshold to determine whether there is a blemish of the image sensor; and storing, transmitting, or displaying an indication of whether there is a blemish of the image sensor.

### CROSS-REFERENCE TO RELATED APPLICATIONS

This application claims the benefit of U.S. Provisional Patent Application No. 62/525,987, filed on Jun. 28, 2017, which is incorporated by reference in its entirety.

### TECHNICAL FIELD

This disclosure relates to image sensor blemish detection.

### BACKGROUND

Image capture devices, such as cameras, may capture content as images or video. Light may be received and focused via a lens and may be converted to an electronic image signal by an image sensor. The image signal may be processed by an image signal processor (ISP) to form an image, which may be stored and/or encoded. In some implementations, multiple images or video frames from different image sensors may include spatially adjacent or overlapping content, which may be stitched together to form a larger image with a larger field of view. Defects can occur in an image capture device (e.g., manufacturing defects) that cause distortion of images captured with the image capture devices. Testing of image quality to detect defects is an important aspect of manufacturing and/or servicing image capture devices.

### SUMMARY

Disclosed herein are implementations of image sensor blemish detection.

In a first aspect, the subject matter described in this specification can be embodied in systems that include an image sensor configured to capture images. The systems include a processing apparatus configured to obtain a test image from the image sensor; apply a low-pass filter to the test image to obtain a blurred image; determine an enhanced image based on a difference between the blurred image and the test image; and compare image portions of the enhanced image to a threshold to determine whether there is a blemish of the image sensor.

In a second aspect, the subject matter described in this specification can be embodied in methods that include obtaining a test image from an image sensor; applying a low-pass filter to the test image to obtain a blurred image; determining an enhanced image based on a difference between the blurred image and the test image; comparing image portions of the enhanced image to a threshold to determine whether there is a blemish of the image sensor; and storing, transmitting, or displaying an indication of whether there is a blemish of the image sensor.

In a third aspect, the subject matter described in this specification can be embodied in systems that include a test surface configured to be illuminated. The systems include a holder, configured to hold a camera in a position such that the test surface appears within a field of view of an image sensor of the camera. The systems include a processing apparatus configured to receive a test image from the camera, where the test image is based on an image captured by the image sensor in which the test surface appears within the field of view; apply a low-pass filter to the test image to obtain a blurred image; determine an enhanced image based on a difference between the blurred image and the test image; and compare image portions of the enhanced image to a threshold to determine whether there is a blemish of the image sensor.

These and other aspects of the present disclosure are disclosed in the following detailed description, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of an image capture system.

FIG. 2A is a block diagram of an example of a system configured for image capture.

FIG. 2B is a block diagram of an example of a system configured for image capture.

FIG. 3 is a flowchart of an example of a technique for image sensor blemish detection.

FIG. 4 is a flowchart of an example of a technique for pre-processing to obtain a test image.

FIG. 5 is a flowchart of an example of a technique for applying a filter to obtain a blurred image.

FIG. 6 is a block diagram of an example of a system for testing image capture devices.

### DETAILED DESCRIPTION

This document includes disclosure of systems, apparatus, and methods for image sensor blemish detection, which may enable quality control for image capture devices.

Quality control is an important task in image capture device (e.g., camera) manufacturing and one of the critical issues is blemish detection. Blemishes are defects of an image sensor that cause distortion of captured images. For example, blemishes may be caused by dust or other contaminants on the sensor surface or embedded in the sensor. Blemishes of an image sensor may manifest in captured images as low contrast and gradually changed regions. Blemishes may be low contrast, gradual changed and may have no particular pattern of shape. These features can make a blemish difficult to be detected. Blemishes can cause a significant reduction in camera quality. Often, manufacturing sites still rely on human inspection of captured images for blemish detection, which is costly. Inspection by human operator may also be impacted on the physical and psychological state of a human inspector, and thus may be inconsistent. Furthermore, some blemishes are nearly invisible to human eyes especially when there is lens shading.

Fast low contrast blemish detection algorithms for camera image quality testing are described herein. The images used in the production testing are typically raw data (e.g., in a Bayer Mosaic format). In some implementations, pre-processing is applied to the raw image data to obtain a test image. The pre-processing may take a raw image as input and output a luminance channel image. For example, the pre-processing of a captured test image may include black level adjustment, white balance, demosaicing and/or color transform.

The test image used for blemish detection may be taken of a bright flat surface, i.e., the bright flat surface may appear in the field of view of an image sensor being tested when the test image is captured. In some implementations, blemish detection is performed on the luminance channel. For example, blemish detection for an image sensor may include performing operations on the test image including down-sampling, de-noise, difference and/or thresholding to determine a blemish map (e.g., a two-dimensional array or image of binary values indicating which pixels or blocks of pixels are impacted by a blemish) for the image sensor. In some implementations, the luminance channel may be first down-sampled (e.g., by factor four). Down-sampling the luminance channel may reduce the noise and speed up the processing. A low-pass filter (e.g., 101×101 pixel average kernel) may then be applied to blur the down-sampled luminance channel test image and make the blemish less apparent. A difference between down-sampled luminance channel test image and the blurred down-sampled luminance channel test image is calculated. A blemish-enhanced image may be determined based on the difference calculation. Finally, blemish detection result may be determined by applying thresholding on the blemish-enhanced image. The threshold may be carefully selected considering the tradeoff between noise sensitivity and detection performance.

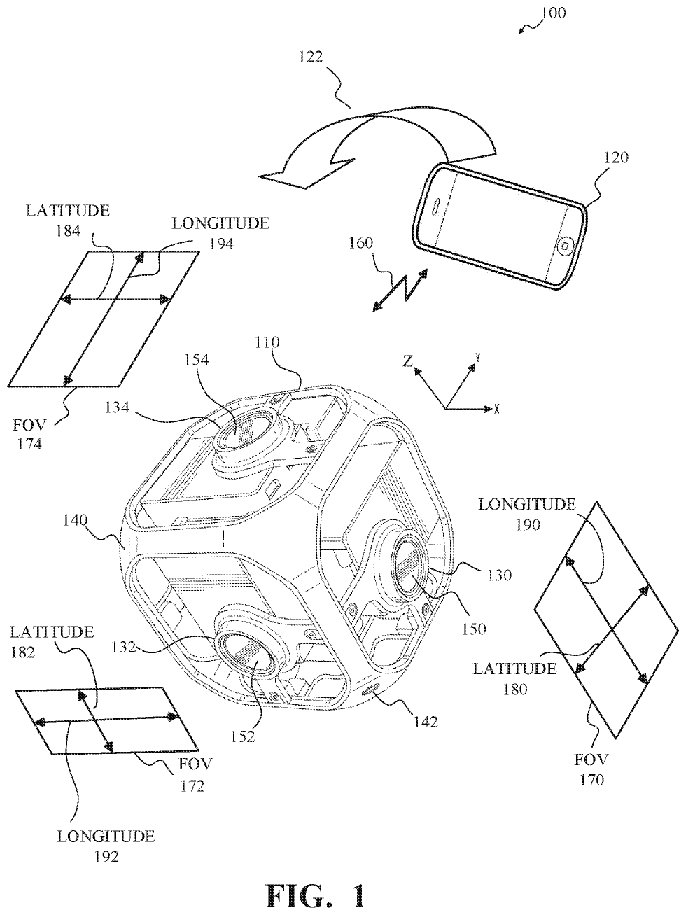

Implementations are described in detail with reference to the drawings, which are provided as examples so as to enable those skilled in the art to practice the technology. For example, systems, or portions thereof, described in relation to FIGS. 1, 2A, 2B, and 6 may be used to implement techniques, in whole or in part, that are described herein. The figures and examples are not meant to limit the scope of the present disclosure to a single implementation or embodiment, and other implementations and embodiments are possible by way of interchange of, or combination with, some or all of the described or illustrated elements. Wherever convenient, the same reference numbers will be used throughout the drawings to refer to same or like parts.

FIG. 1 is a diagram of an example of an image capture system 100 for content capture. As shown in FIG. 1, an image capture system 100 may include an image capture apparatus 110, an external user interface (UI) device 120, or a combination thereof.

In some implementations, the image capture apparatus 110 may be a multi-face apparatus and may include multiple image capture devices, such as image capture devices 130, 132, 134 as shown in FIG. 1, arranged in a structure 140, such as a cube-shaped cage as shown. Although three image capture devices 130, 132, 134 are shown for simplicity in FIG. 1, the image capture apparatus 110 may include any number of image capture devices. For example, the image capture apparatus 110 shown in FIG. 1 may include six cameras, which may include the three image capture devices 130, 132, 134 shown and three cameras not shown.

In some implementations, the structure 140 may have dimensions, such as between 25 mm and 150 mm. For example, the length of each side of the structure 140 may be 105 mm. The structure 140 may include a mounting port 142, which may be removably attachable to a supporting structure, such as a tripod, a photo stick, or any other camera mount (not shown). The structure 140 may be a rigid support structure, such that the relative orientation of the image capture devices 130, 132, 134 of the image capture apparatus 110 may be maintained in relatively static or fixed alignment, except as described herein.

The image capture apparatus 110 may obtain, or capture, image content, such as images, video, or both, with a 360° field-of-view, which may be referred to herein as panoramic or spherical content. For example, each of the image capture devices 130, 132, 134 may include respective lenses, for receiving and focusing light, and respective image sensors for converting the received and focused light to an image signal, such as by measuring or sampling the light, and the multiple image capture devices 130, 132, 134 may be arranged such that respective image sensors and lenses capture a combined field-of-view characterized by a spherical or near spherical field-of-view.

In some implementations, each of the image capture devices 130, 132, 134 may have a respective field-of-view 170, 172, 174, such as a field-of-view 170, 172, 174 that 90° in a lateral dimension 180, 182, 184 and includes 120° in a longitudinal dimension 190, 192, 194. In some implementations, image capture devices 130, 132, 134 having overlapping fields-of-view 170, 172, 174, or the image sensors thereof, may be oriented at defined angles, such as at 90°, with respect to one another. In some implementations, the image sensor of the image capture device 130 is directed along the X axis, the image sensor of the image capture device 132 is directed along the Y axis, and the image sensor of the image capture device 134 is directed along the Z axis. The respective fields-of-view 170, 172, 174 for adjacent image capture devices 130, 132, 134 may be oriented to allow overlap for a stitching function. For example, the longitudinal dimension 190 of the field-of-view 170 for the image capture device 130 may be oriented at 90° with respect to the latitudinal dimension 184 of the field-of-view 174 for the image capture device 134, the latitudinal dimension 180 of the field-of-view 170 for the image capture device 130 may be oriented at 90° with respect to the longitudinal dimension 192 of the field-of-view 172 for the image capture device 132, and the latitudinal dimension 182 of the field-of-view 172 for the image capture device 132 may be oriented at 90° with respect to the longitudinal dimension 194 of the field-of-view 174 for the image capture device 134.

The image capture apparatus 110 shown in FIG. 1 may have 420° angular coverage in vertical and/or horizontal planes by the successive overlap of 90°, 120°, 90°, 120° respective fields-of-view 170, 172, 174 (not all shown) for four adjacent image capture devices 130, 132, 134 (not all shown). For example, fields-of-view 170, 172 for the image capture devices 130, 132 and fields-of-view (not shown) for two image capture devices (not shown) opposite the image capture devices 130, 132 respectively may be combined to provide 420° angular coverage in a horizontal plane. In some implementations, the overlap between fields-of-view of image capture devices 130, 132, 134 having a combined field-of-view including less than 360° angular coverage in a vertical and/or horizontal plane may be aligned and merged or combined to produce a panoramic image. For example, the image capture apparatus 110 may be in motion, such as rotating, and source images captured by at least one of the image capture devices 130, 132, 134 may be combined to form a panoramic image. As another example, the image capture apparatus 110 may be stationary, and source images captured contemporaneously by each image capture device 130, 132, 134 may be combined to form a panoramic image.

In some implementations, an image capture device 130, 132, 134 may include a lens 150, 152, 154 or other optical element. An optical element may include one or more lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, other lens, and/or other optical element. In some implementations, a lens 150, 152, 154 may be a fisheye lens and produce fisheye, or near-fisheye, field-of-view images. For example, the respective lenses 150, 152, 154 of the image capture devices 130, 132, 134 may be fisheye lenses. In some implementations, images captured by two or more image capture devices 130, 132, 134 of the image capture apparatus 110 may be combined by stitching or merging fisheye projections of the captured images to produce an equirectangular planar image. For example, a first fisheye image may be a round or elliptical image, and may be transformed to a first rectangular image, a second fisheye image may be a round or elliptical image, and may be transformed to a second rectangular image, and the first and second rectangular images may be arranged side-by-side, which may include overlapping, and stitched together to form the equirectangular planar image.

Although not expressly shown in FIG. 1, in some implementations, each of the image capture devices 130, 132, 134 may include one or more image sensors, such as a charge-coupled device (CCD) sensor, an active pixel sensor (APS), a complementary metal-oxide semiconductor (CMOS) sensor, an N-type metal-oxide-semiconductor (NMOS) sensor, and/or any other image sensor or combination of image sensors.

Although not expressly shown in FIG. 1, in some implementations, the image capture apparatus 110 may include one or more microphones, which may receive, capture, and record audio information, which may be associated with images acquired by the image sensors.

Although not expressly shown in FIG. 1, the image capture apparatus 110 may include one or more other information sources or sensors, such as an inertial measurement unit (IMU), a global positioning system (GPS) receiver component, a pressure sensor, a temperature sensor, a heart rate sensor, or any other unit, or combination of units, that may be included in an image capture apparatus.

In some implementations, the image capture apparatus 110 may interface with or communicate with an external device, such as the external user interface (UI) device 120, via a wired (not shown) or wireless (as shown) computing communication link 160. Although a single computing communication link 160 is shown in FIG. 1 for simplicity, any number of computing communication links may be used. Although the computing communication link 160 shown in FIG. 1 is shown as a direct computing communication link, an indirect computing communication link, such as a link including another device or a network, such as the internet, may be used. In some implementations, the computing communication link 160 may be a Wi-Fi link, an infrared link, a Bluetooth (BT) link, a cellular link, a ZigBee link, a near field communications (NFC) link, such as an ISO/IEC 23243 protocol link, an Advanced Network Technology interoperability (ANT+) link, and/or any other wireless communications link or combination of links. In some implementations, the computing communication link 160 may be an HDMI link, a USB link, a digital video interface link, a display port interface link, such as a Video Electronics Standards Association (VESA) digital display interface link, an Ethernet link, a Thunderbolt link, and/or other wired computing communication link.

In some implementations, the user interface device 120 may be a computing device, such as a smartphone, a tablet computer, a phablet, a smart watch, a portable computer, and/or another device or combination of devices configured to receive user input, communicate information with the image capture apparatus 110 via the computing communication link 160, or receive user input and communicate information with the image capture apparatus 110 via the computing communication link 160.

In some implementations, the image capture apparatus 110 may transmit images, such as panoramic images, or portions thereof, to the user interface device 120 via the computing communication link 160, and the user interface device 120 may store, process, display, or a combination thereof the panoramic images.

In some implementations, the user interface device 120 may display, or otherwise present, content, such as images or video, acquired by the image capture apparatus 110. For example, a display of the user interface device 120 may be a viewport into the three-dimensional space represented by the panoramic images or video captured or created by the image capture apparatus 110.

In some implementations, the user interface device 120 may communicate information, such as metadata, to the image capture apparatus 110. For example, the user interface device 120 may send orientation information of the user interface device 120 with respect to a defined coordinate system to the image capture apparatus 110, such that the image capture apparatus 110 may determine an orientation of the user interface device 120 relative to the image capture apparatus 110. Based on the determined orientation, the image capture apparatus 110 may identify a portion of the panoramic images or video captured by the image capture apparatus 110 for the image capture apparatus 110 to send to the user interface device 120 for presentation as the viewport. In some implementations, based on the determined orientation, the image capture apparatus 110 may determine the location of the user interface device 120 and/or the dimensions for viewing of a portion of the panoramic images or video.

In an example, a user may rotate (sweep) the user interface device 120 through an arc or path 122 in space, as indicated by the arrow shown at 122 in FIG. 1. The user interface device 120 may communicate display orientation information to the image capture apparatus 110 using a communication interface such as the computing communication link 160. The image capture apparatus 110 may provide an encoded bitstream to enable viewing of a portion of the panoramic content corresponding to a portion of the environment of the display location as the image capture apparatus 110 traverses the path 122. Accordingly, display orientation information from the user interface device 120 may be transmitted to the image capture apparatus 110 to control user selectable viewing of captured images and/or video.

In some implementations, the image capture apparatus 110 may communicate with one or more other external devices (not shown) via wired or wireless computing communication links (not shown).

In some implementations, data, such as image data, audio data, and/or other data, obtained by the image capture apparatus 110 may be incorporated into a combined multimedia stream. For example, the multimedia stream may include a video track and/or an audio track. As another example, information from various metadata sensors and/or sources within and/or coupled to the image capture apparatus 110 may be processed to produce a metadata track associated with the video and/or audio track. The metadata track may include metadata, such as white balance metadata, image sensor gain metadata, sensor temperature metadata, exposure time metadata, lens aperture metadata, bracketing configuration metadata and/or other parameters. In some implementations, a multiplexed stream may be generated to incorporate a video and/or audio track and one or more metadata tracks.

In some implementations, the user interface device 120 may implement or execute one or more applications, such as GoPro Studio, GoPro App, or both, to manage or control the image capture apparatus 110. For example, the user interface device 120 may include an application for controlling camera configuration, video acquisition, video display, or any other configurable or controllable aspect of the image capture apparatus 110.

In some implementations, the user interface device 120, such as via an application (e.g., GoPro App), may generate and share, such as via a cloud-based or social media service, one or more images, or short video clips, such as in response to user input.

In some implementations, the user interface device 120, such as via an application (e.g., GoPro App), may remotely control the image capture apparatus 110, such as in response to user input.

In some implementations, the user interface device 120, such as via an application (e.g., GoPro App), may display unprocessed or minimally processed images or video captured by the image capture apparatus 110 contemporaneously with capturing the images or video by the image capture apparatus 110, such as for shot framing, which may be referred to herein as a live preview, and which may be performed in response to user input.

In some implementations, the user interface device 120, such as via an application (e.g., GoPro App), may mark one or more key moments contemporaneously with capturing the images or video by the image capture apparatus 110, such as with a HiLight Tag, such as in response to user input.

In some implementations, the user interface device 120, such as via an application (e.g., GoPro App), may display, or otherwise present, marks or tags associated with images or video, such as HiLight Tags, such as in response to user input. For example, marks may be presented in a GoPro Camera Roll application for location review and/or playback of video highlights.

In some implementations, the user interface device 120, such as via an application (e.g., GoPro App), may wirelessly control camera software, hardware, or both. For example, the user interface device 120 may include a web-based graphical interface accessible by a user for selecting a live or previously recorded video stream from the image capture apparatus 110 for display on the user interface device 120.

In some implementations, the user interface device 120 may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture apparatus 110.

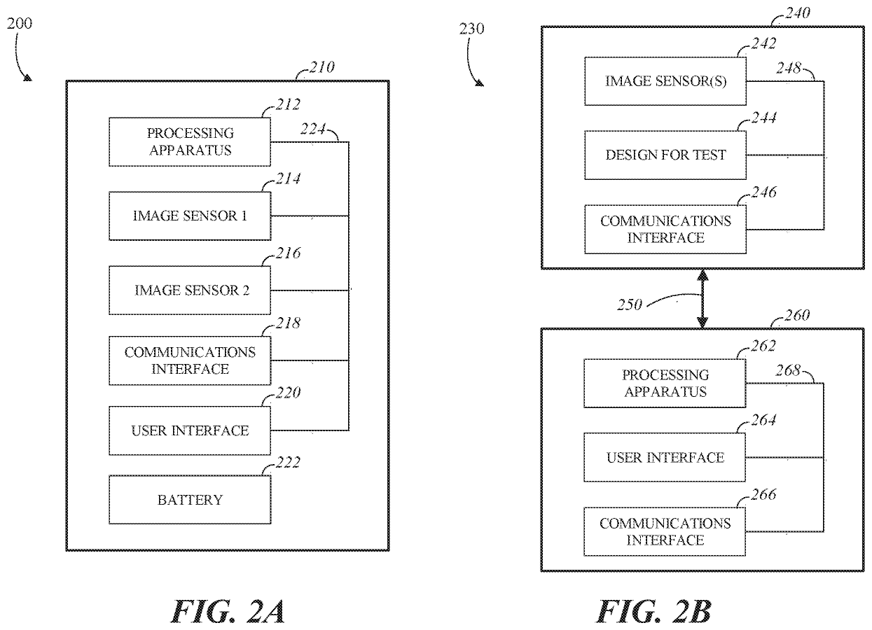

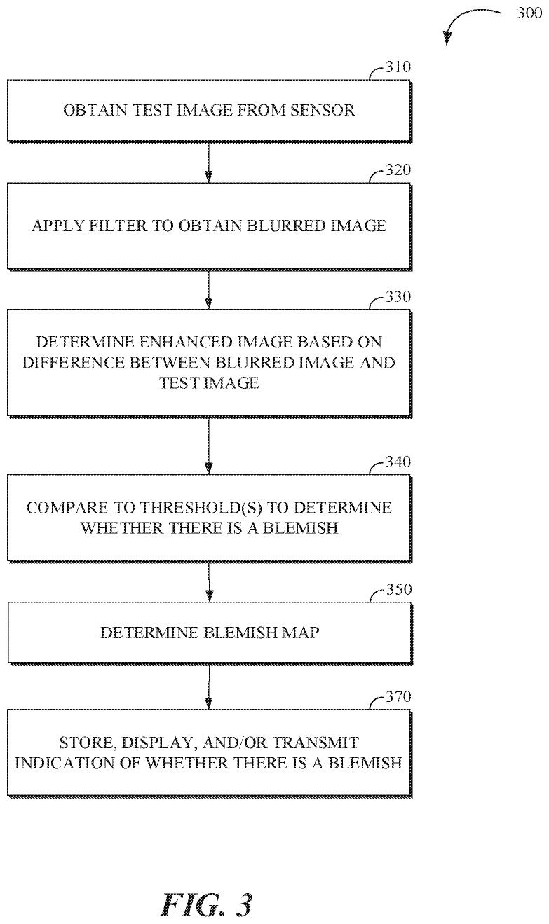

FIG. 2A is a block diagram of an example of a system 200 configured for image capture. The system 200 includes an image capture device 210 (e.g., a camera or a drone) that includes a processing apparatus 212 that is configured to receive a first image from the first image sensor 214 and receive a second image from the second image sensor 216. The processing apparatus 212 may be configured to perform image signal processing (e.g., filtering, stitching, and/or encoding) to generate composite images based on image data from the image sensors 214 and 216. The image capture device 210 includes a communications interface 218 for transferring images to other devices. The image capture device 210 includes a user interface 220, which may allow a user to control image capture functions and/or view images. The image capture device 210 includes a battery 222 for powering the image capture device 210. The components of the image capture device 210 may communicate with each other via the bus 224. The system 200 may be used to implement techniques described in this disclosure, such as the technique 300 of FIG. 3.

The processing apparatus 212 may include one or more processors having single or multiple processing cores. The processing apparatus 212 may include memory, such as random access memory device (RAM), flash memory, or any other suitable type of storage device such as a non-transitory computer readable memory. The memory of the processing apparatus 212 may include executable instructions and data that can be accessed by one or more processors of the processing apparatus 212. For example, the processing apparatus 212 may include one or more DRAM modules such as double data rate synchronous dynamic random-access memory (DDR SDRAM). In some implementations, the processing apparatus 212 may include a digital signal processor (DSP). In some implementations, the processing apparatus 212 may include an application specific integrated circuit (ASIC). For example, the processing apparatus 212 may include a custom image signal processor.

The first image sensor 214 and the second image sensor 216 are configured to capture images. For example, the first image sensor 214 and the second image sensor 216 may be configured to detect light of a certain spectrum (e.g., the visible spectrum or the infrared spectrum) and convey information constituting an image as electrical signals (e.g., analog or digital signals). For example, the image sensors 214 and 216 may include charge-coupled devices (CCD) or active pixel sensors in complementary metal-oxide-semiconductor (CMOS). The image sensors 214 and 216 may detect light incident through respective lens (e.g., a fisheye lens). In some implementations, the image sensors 214 and 216 include digital to analog converters. In some implementations, the image sensors 214 and 216 are held in a fixed orientation with respective fields of view that overlap.

The image capture device 210 may include a communications interface 218, which may enable communications with a personal computing device (e.g., a smartphone, a tablet, a laptop computer, or a desktop computer). For example, the communications interface 218 may be used to receive commands controlling image capture and processing in the image capture device 210. For example, the communications interface 218 may be used to transfer image data to a personal computing device. For example, the communications interface 218 may include a wired interface, such as a high-definition multimedia interface (HDMI), a universal serial bus (USB) interface, or a FireWire interface. For example, the communications interface 218 may include a wireless interface, such as a Bluetooth interface, a ZigBee interface, and/or a Wi-Fi interface.

The image capture device 210 may include a user interface 220. For example, the user interface 220 may include an LCD display for presenting images and/or messages to a user. For example, the user interface 220 may include a button or switch enabling a person to manually turn the image capture device 210 on and off. For example, the user interface 220 may include a shutter button for snapping pictures.

The image capture device 210 may include a battery 222 that powers the image capture device 210 and/or its peripherals. For example, the battery 222 may be charged wirelessly or through a micro-USB interface.

FIG. 2B is a block diagram of an example of a system 230 configured for image capture. The system 230 includes an image capture device 240 and a computing device 260 that communicate via a communications link 250. While the image capture device 210 may include all of its components within a single physically connected structure, the system 230 may include components that are not physically in contact with one another (e.g., where the communications link 250 is a wireless communications link). The image capture device 240 includes one or more image sensors 242 that are configured to capture respective images. The image capture device 240 includes a design for test module 244 that may implement special protocols to generate diagnostic data (e.g., raw test images) and communicate the diagnostic data to device operated by a user or technician who is testing or servicing the image capture device 240. The image capture device 240 includes a communications interface 246 configured to transfer images via the communication link 250 to the computing device 260. The computing device 260 includes a processing apparatus 262 that is configured to receive, using the communications interface 266, images from the one or more image sensors 242. The processing apparatus 262 may be configured to perform image signal processing (e.g., filtering, stitching, and/or encoding) to generate composite images based on image data from the image sensors 242. For example, the computing device 260 may be operated by a user (e.g., a consumer or end user) or technician who testing or servicing the image capture device 240. The system 230 may be used to implement techniques described in this disclosure, such as the technique 300 of FIG. 3.

The one or more image sensors 242 are configured to detect light of a certain spectrum (e.g., the visible spectrum or the infrared spectrum) and convey information constituting an image as electrical signals (e.g., analog or digital signals). For example, the image sensors 242 may include charge-coupled devices (CCD) or active pixel sensors in complementary metal-oxide-semiconductor (CMOS). The image sensors 242 may detect light incident through respective lens (e.g., a fisheye lens). In some implementations, the image sensors 242 include digital to analog converters. In some implementations, the image sensors 242 are held in a fixed relative orientation with respective fields of view that overlap. Image signals from the image sensors 242 may be passed to other components of the image capture device 240 via the bus 248.

The design for test module 244 may be configured to facilitate testing of the image capture device 240. For example, the design for test module 244 may enable testing protocols for gathering diagnostic data from components of the image capture device 240, such as raw test images captured by the one or more image sensors 242. In some implementations, the design for test module 244 may provide a dedicated wired communication interface (e.g., a serial port) for transferring diagnostic data to an external processing apparatus for processing and analysis. In some implementations, the design for test module 244 may pass diagnostic data to the communications interface 246, which is used for regular image data and commands, for transferring diagnostic data to an external processing apparatus for processing and analysis.

The communications link 250 may be a wired communications link or a wireless communications link. The communications interface 246 and the communications interface 266 may enable communications over the communications link 250. For example, the communications interface 246 and the communications interface 266 may include a high-definition multimedia interface (HDMI), a universal serial bus (USB) interface, a FireWire interface, a Bluetooth interface, a ZigBee interface, and/or a Wi-Fi interface. For example, the communications interface 246 and the communications interface 266 may be used to transfer image data from the image capture device 240 to the computing device 260 for image signal processing (e.g., filtering, stitching, and/or encoding) to generated composite images based on image data from the image sensors 242.

The processing apparatus 262 may include one or more processors having single or multiple processing cores. The processing apparatus 262 may include memory, such as random access memory device (RAM), flash memory, or any other suitable type of storage device such as a non-transitory computer readable memory. The memory of the processing apparatus 262 may include executable instructions and data that can be accessed by one or more processors of the processing apparatus 262. For example, the processing apparatus 262 may include one or more DRAM modules such as double data rate synchronous dynamic random-access memory (DDR SDRAM). In some implementations, the processing apparatus 262 may include a digital signal processor (DSP). In some implementations, the processing apparatus 262 may include an application specific integrated circuit (ASIC). For example, the processing apparatus 262 may include a custom image signal processor. The processing apparatus 262 may exchange data (e.g., image data) with other components of the computing device 260 via the bus 268.

The computing device 260 may include a user interface 264. For example, the user interface 264 may include a touchscreen display for presenting images and/or messages to a user (e.g., a technician) and receiving commands from a user. For example, the user interface 264 may include a button or switch enabling a person to manually turn the computing device 260 on and off. In some implementations, commands (e.g., start recording video, stop recording video, snap photograph or initiate image sensor test) received via the user interface 264 may be passed on to the image capture device 240 via the communications link 250.

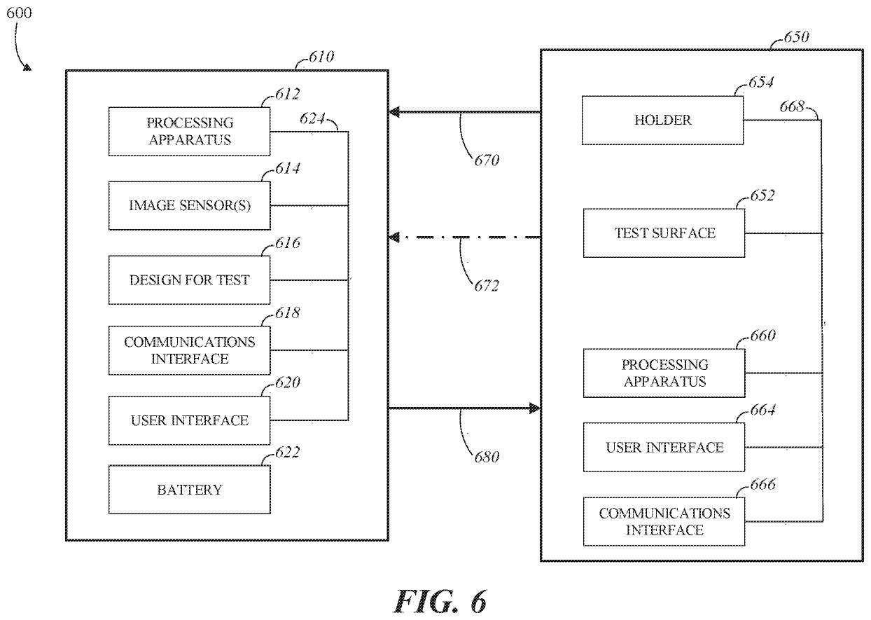

FIG. 3 is a flowchart of an example of a technique 300 for image sensor blemish detection. The technique 300 includes obtaining 310 a test image from an image sensor; applying 320 a low-pass filter to the test image to obtain a blurred image; determining 330 an enhanced image based on a difference between the blurred image and the test image; comparing 340 image portions of the enhanced image to a threshold to determine whether there is a blemish of the image sensor; determining 350 a blemish map by applying the threshold to the enhanced image; and storing, transmitting, or displaying 370 an indication of whether there is a blemish of the image sensor. For example, the technique 300 may be implemented by the system 200 of FIG. 2A or the system 230 of FIG. 2B. For example, the technique 300 may be implemented by an image capture device, such the image capture device 210 shown in FIG. 2, or an image capture apparatus, such as the image capture apparatus 110 shown in FIG. 1. For example, the technique 300 may be implemented by a personal computing device, such as the computing device 260. For example, the technique 300 may be implemented by the camera testing apparatus 650 of FIG. 6.

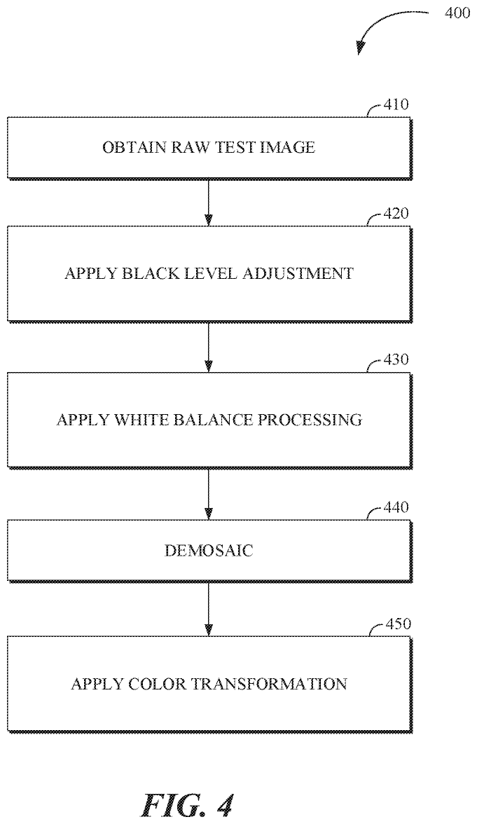

The technique 300 includes obtaining 310 a test image from an image sensor. For example, the test image may be a luminance level image. In some implementations, obtaining 310 a test image includes obtaining a raw test image from the image sensor; and applying one or more pre-processing operations to the raw test image to obtain the test image, where the one or more pre-processing operations include at least one of black level adjustment, white balance, demosaicing, or color transformation. For example, the technique 400 of FIG. 4 (described below) may be implemented to obtain 310 the test image from the image sensor. In some implementations, the test image may be based on an image captured while a test surface is positioned in a field of view of the image sensor. For example, the test surface may be illuminated with uniform brightness across the field of view, For example, the test surface may be a light emitting diode panel. For example, obtaining 310 the test image may include reading an image from the sensor or a memory via a bus (e.g., via the bus 224). For example, obtaining 310 the test image may include receiving an image via a communications interface (e.g., the communications interface 266 or the communications interface 666).

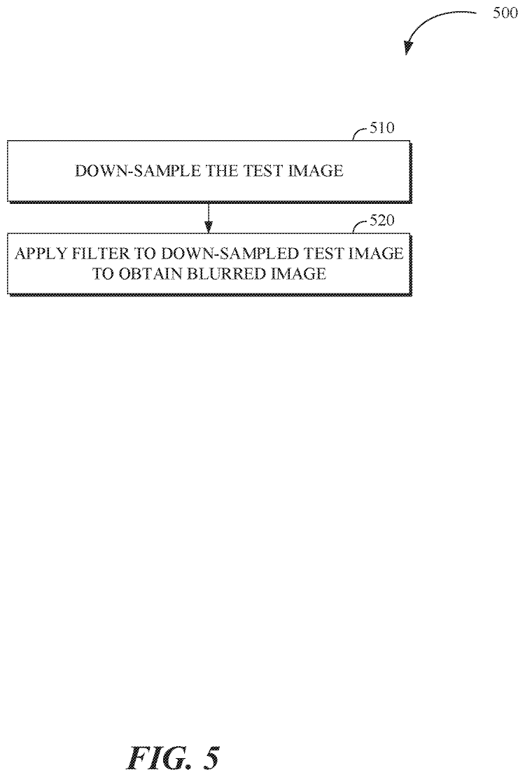

The technique 300 includes applying 320 a low-pass filter to the test image to obtain a blurred image. For example, applying 320 the low-pass filter to the test image may include convolving a square average kernel (e.g., a 101×101 pixel average kernel) with the test image. Other kernels may be used, such as a Guassian kernel. In some implementations, the test image may be down-sampled prior to applying 320 a low-pass filter. For example, the technique 500 of FIG. 5 may be implemented to apply 320 a low-pass filter to the test image to obtain the blurred image. In some implementations, the test image and the blurred image may be down-sampled after applying 320 a low-pass filter to the test image to obtain a blurred image.

The technique 300 includes determining 330 an enhanced image based on a difference between the blurred image and the test image. For example, the enhanced image may be determined as equal to a difference between the blurred image and the test image.

The technique 300 includes comparing 340 image portions of the enhanced image to a threshold to determine whether there is a blemish of the image sensor. In some implementations, if at least one image portion (e.g., a pixel or block of pixels) has a value exceeding the threshold, then it is determined that there is a blemish of the image sensor (e.g., the image sensor is defective or has failed the test). In some implementations, if at least N image portions (e.g., N equal to 5% or 10% of the image portions for the image sensor) have a value exceeding the threshold, then it is determined that there is a blemish of the image sensor (e.g., the image sensor is defective or has failed the test).

The technique 300 includes determining 350 a blemish map by applying the threshold to the enhanced image. For example, the blemish map may be an array (e.g., a two dimensional array) of binary values indicating whether a blemish has been detected at a respective image portion (e.g., a pixel or block of pixels) for the image sensor under test. For example, for image portions of the enhanced image that include one or more values exceeding the threshold, a corresponding binary value in the blemish map may set to one or true, and set zero or false otherwise. In some implementations (not shown), the determining 350 the blemish map may be combined with the comparing 340 step. For example, a blemish map may be determined 350 by comparing 340 image portions of the enhanced image to a threshold and whether a blemish is present for the image sensor as a whole can be determined based on values in the blemish map. In some implementations (not shown), the step of determining 350 the blemish map may be omitted (e.g., where we are interested in whether a blemish defect exists at all for the image sensor and not interested in investing what portion(s) of the image sensor are impacted).

The technique 300 includes storing, transmitting, or displaying 370 an indication of whether there is a blemish of the image sensor. The indication may, for example, include a “pass” or a “fail” message. For example, the indication may include the blemish map. The indication may, for example, be transmitted to an external device (e.g., a personal computing device) for display or storage. For example, the indication may be stored by the processing apparatus 212, by the processing apparatus 262, or by the processing apparatus 660. The indication may, for example, be displayed in the user interface 220, in the user interface 264, or in the user interface 664. For example, the indication may be transmitted via the communications interface 218, via the communication interface 266, or via the communication interface 666.

FIG. 4 is a flowchart of an example of a technique 400 for pre-processing to obtain a test image. The technique 400 includes obtaining 410 a raw test image from the image sensor; applying 420 black level adjustment; applying 430 white balance processing; demosaicing 440; and applying 450 color transformation. For example, the technique 400 may be implemented by the system 200 of FIG. 2A or the system 230 of FIG. 2B. For example, the technique 400 may be implemented by an image capture device, such the image capture device 210 shown in FIG. 2, or an image capture apparatus, such as the image capture apparatus 110 shown in FIG. 1. For example, the technique 400 may be implemented by a personal computing device, such as the computing device 260. For example, the technique 400 may be implemented by the camera testing apparatus 650 of FIG. 6.

The technique 400 includes obtaining 410 a raw test image from the image sensor. For example, obtaining 410 the raw test image may include reading an image from the sensor or a memory via a bus (e.g., via the bus 224). For example, obtaining 410 the raw test image may include receiving an image via a communications interface (e.g., the communications interface 266 or the communications interface 666).

The technique 400 includes applying 420 black level adjustment to the raw test image.

The technique 400 includes applying 430 white balance processing to the raw test image.

The technique 400 includes demosaicing 440 the raw test image. For example, the raw test image from the sensor may be captured with a color filter array (e.g., a Bayer filter mosaic). Image data based on the raw test image may be demosaiced 440 by interpolating missing color channel values based on nearby pixel values to obtain three color channel values for all the pixels of the test image.

The technique 400 includes applying 450 color transformation to the image. For example, the image may be transformed from an RGB (red, green, blue) representation a YUV (luminance and two chrominance components). In some implementations, a particular component or channel (e.g., the luminance channel) of the transformed image may be selected for further processing and returned as the test image.

FIG. 5 is a flowchart of an example of a technique 500 for applying a filter to obtain a blurred image. The technique 500 includes down-sampling 510 (e.g., by a factor of four or sixteen) the test image to obtain a down-sampled test image; and applying 520 the low-pass filter (e.g., an average kernel or a Guassian kernel) to the down-sampled test image. For example, the technique 500 may be implemented by the system 200 of FIG. 2A or the system 230 of FIG. 2B. For example, the technique 500 may be implemented by an image capture device, such the image capture device 210 shown in FIG. 2, or an image capture apparatus, such as the image capture apparatus 110 shown in FIG. 1. For example, the technique 500 may be implemented by a personal computing device, such as the computing device 260. For example, the technique 500 may be implemented by the camera testing apparatus 650 of FIG. 6.

FIG. 6 is a block diagram of an example of a system 600 for testing image capture devices. The system 600 includes a camera 610 that is being tested and a camera testing apparatus 650. The camera 610 may include a processing apparatus 612 that is configured to receive images from one or more image sensors 614. The processing apparatus 612 may be configured to perform image signal processing (e.g., filtering, stitching, and/or encoding) to generated composite images based on image data from the image sensors 614. The camera 610 may include a design for test module 616, which may be configured to facilitate testing of the camera 610. For example, the design for test module 616 may enable testing protocols for gathering diagnostic data from components of the camera 610, such as raw test images captured by the one or more image sensors 614. In some implementations, the design for test module 616 may provide a dedicated wired communication interface (e.g., a serial port) for transferring diagnostic data to an external processing apparatus for processing and analysis. The camera 610 includes a communications interface 618 for transferring images to other devices. In some implementations, the design for test module 616 may pass diagnostic data to the communications interface 618, which is used for regular image data and commands, for transferring diagnostic data to an external processing apparatus, such as the camera testing apparatus 650, for processing and analysis. The camera 610 includes a user interface 620, which may allow a user to control image capture functions and/or view images. The camera 610 includes a battery 622 for powering the camera 610. The components of the camera 610 may communicate with each other via the bus 624.

The camera testing apparatus 650 includes a test surface 652 that is configured to be illuminated and a holder 654 that is configured to hold a camera in a position such that the test surface appears within a field of view of an image sensor 614 of the camera. For example, the test surface 652 may be illuminated with uniform brightness across the field of view, For example, the test surface 652 may be a light emitting diode panel. In some implementations, the test surface 652 may be flat. The camera testing apparatus 650 includes a processing apparatus 660 that may be configured to receive a test image from the camera 610, where the test image is based on an image captured by the image sensor(s) 614 in which the test surface 652 appears within the field of view; apply a low-pass filter to the test image to obtain a blurred image; determine an enhanced image based on a difference between the blurred image and the test image; and compare image portions of the enhanced image to a threshold to determine whether there is a blemish of the image sensor(s) 614. For example, the processing apparatus 660 may implement the technique 300 of FIG. 3.

The camera testing apparatus 650 may include a user interface 664. For example, the user interface 664 may include a touchscreen display for presenting images and/or messages to a user (e.g., a technician) and receiving commands from a user. For example, the user interface 664 may include buttons, switches, or other input devices enabling a person to control testing of cameras with the camera testing apparatus 650. The camera testing apparatus 650 may include a communications interface 666. For example, the communications interface 666 may include a high-definition multimedia interface (HDMI), a universal serial bus (USB) interface, a FireWire interface, a Bluetooth interface, a ZigBee interface, and/or a Wi-Fi interface. For example, the communications interface 666 may be used to transfer image data from the camera 610 to the camera testing apparatus 650 for image sensor testing based on image data from the image sensor(s) 614. In some implementations, the communications interface 666 be used to transfer commands (e.g., initiate image sensor test) to the camera 610. For example, messages from the communications interface 666 may be passed through the communications interface 618 of the camera or through a dedicated interface of the design for test module 616 (e.g., a serial port). The components of the camera testing apparatus 650 may communicate with each other via the bus 668.

Once the camera 610 is secured in a desired position by the holder 654, the processing apparatus 660 may cause a command 670 (e.g., initiate image sensor test) to be sent to the camera 610. In response, to the command 670 (e.g., using logic provided by the design for test module 616), the camera 610 may capture an image 672 that includes a view of the test surface 652 within its field of view using the image sensor(s) 614. A resulting raw test image 680 from the image sensor(s) 614 may be transferred to the camera testing apparatus 650 (e.g., via the communications interface 666) for processing and analysis to complete a test of the image sensor(s) 614 for blemishes. For example an indication of a result of the test may be stored by the processing apparatus 660, displayed in the user interface 664 (e.g., to a technician), and/or transmitted to another device (e.g., a networked server) via the communications interface 666.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A system comprising:
an image sensor configured to capture images; and
a processing apparatus configured to:
obtain a test image from the image sensor;
apply a low-pass filter to the test image to obtain a blurred image;
determine an enhanced image based on a difference between the blurred image and the test image; and
compare image portions of the enhanced image to a threshold to determine whether there is a blemish of the image sensor.

2. The system of claim 1, in which the processing apparatus is configured to:
determine a blemish map by applying the threshold to the enhanced image.

3. The system of claim 1, in which applying the low-pass filter to the test image comprises convolving a square average kernel with the test image.

4. The system of claim 1, in which the test image is based on an image captured while a test surface is positioned in a field of view of the image sensor.

5-15. (canceled)

16. The system of claim 4, in which the test surface is a light emitting diode panel.

17. The system of claim 4, in which the test surface is illuminated with uniform brightness across the field of view.

18. The system of claim 1, in which applying the low-pass filter to the test image comprises:
down-sampling the test image to obtain a down-sampled test image; and
applying the low-pass filter to the down-sampled test image.

19. The system of claim 1, in which the test image is a luminance level image.

20. The system of claim 19, in which obtaining the test image from the image sensor comprises:
obtaining a raw test image from the image sensor; and
apply one or more pre-processing operations to the raw test image to obtain the test image, wherein the one or more pre-processing operations include at least one of black level adjustment, white balance, demosaicing, or color transformation.

21. The system of claim 1, in which the processing apparatus is configured to:
store, transmit, or display an indication of whether there is a blemish of the image sensor.

22. A method comprising:
obtaining a test image from an image sensor;
applying a low-pass filter to the test image to obtain a blurred image;
determining an enhanced image based on a difference between the blurred image and the test image;
comparing image portions of the enhanced image to a threshold to determine whether there is a blemish of the image sensor; and
storing, transmitting, or displaying an indication of whether there is a blemish of the image sensor.

23. The method of claim 22, comprising:
determining a blemish map by applying the threshold to the enhanced image.

24. The method of claim 22, in which applying the low-pass filter to the test image comprises convolving a square average kernel with the test image.

25. The method of claim 22, in which the test image is based on an image captured while a test surface is positioned in a field of view of the image sensor.

26. The method of claim 25, in which the test surface is a light emitting diode panel.

27. The method of claim 25, in which the test surface is illuminated with uniform brightness across the field of view.

28. The method of claim 22, in which applying the low-pass filter to the test image comprises:
down-sampling the test image to obtain a down-sampled test image; and
applying the low-pass filter to the down-sampled test image.

29. A system comprising:
a test surface configured to be illuminated;
a holder configured to hold a camera in a position such that the test surface appears within a field of view of an image sensor of the camera; and
a processing apparatus configured to:
receive a test image from the camera, wherein the test image is based on an image captured by the image sensor in which the test surface appears within the field of view;
apply a low-pass filter to the test image to obtain a blurred image;
determine an enhanced image based on a difference between the blurred image and the test image; and
compare image portions of the enhanced image to a threshold to determine whether there is a blemish of the image sensor.

30. The system of claim 29, in which the test surface is a light emitting diode panel.

31. The system of claim 29, in which the test surface is illuminated with uniform brightness across the field of view.
